(19) United States
(12) Patent Application Publication
(10) Pub. No.: US 2025/0160360 A1
(43) Pub. Date: May 22, 2025

(54) Process For Solubilizing Proteins

(71) Applicant: AGENCY FOR SCIENCE, TECHNOLOGY AND RESEARCH, Singapore (SG)

(72) Inventors: Yong Jie Shaun Sim, Singapore (SG); Christiani Jeyakumar Henry, Singapore (SG)

(21) Appl. No.: 18/832,799

(22) PCT Filed: Jan. 11, 2023
(86) PCT No.: PCT/SG2023/050023

§ 371 Date: Jul. 24, 2024

(30) Foreign Application Priority Data
Jan. 27, 2022 (SG) 10202200843Q

(51) Int. Cl. A23J 3/14; A23J 3/22

(52) U.S. Cl. CPC A23J 3/14; A23J 3/22

(57) ABSTRACT

Disclosed herein is a process for solubilizing a protein comprising the step of subjecting a dispersion of an untreated protein to a pressure in the range of 250 MPa to 650 Mpa and a Ph in the range of 1 to 3 or 9 to 14 to solubilize the untreated protein to form the solubilized protein. Disclosed herein is also a process of forming a food composition from the solubilized protein as described herein.

### CROSS-REFERENCE TO RELATED APPLICATIONS

This application claims priority to Singapore provisional application no. 10202200843Q filed on 27 Jan. 2022 with the Intellectual Property Office of Singapore, the contents of which are incorporated by reference.

### TECHNICAL FIELD

The present invention relates generally to a process for solubilizing proteins and a process of forming a food composition comprising the solubilized protein prepared by the process as described herein.

### BACKGROUND ART

With an ever-increasing global population, there is a growing interest to address the global food security concerns that will inevitably arise. Alternatives to current animal-based protein sources, such as livestock agriculture, are being explored and in consideration of working towards a more environmentally sustainable way of producing food, there is an increasing demand to using plant-based protein food sources.

However, just like for several animal-based proteins (e.g., collagen and gelatin), there exists many limitations of plant-based proteins that restrict its use in food products, such as their comparatively poor functionality, poor solubility, and poor foaming, gelling and emulsifying properties. These limitations hinder the use of plant-based proteins in food products, for example, up to 75% of proteins present in pea protein isolates are insoluble and non-functional, and hence remain underutilized.

Currently, high-pressure processing techniques are mainly used for the pasteurization of food but do not functionalize plant protein. To address this, high temperature thermal treatment (100-160° C.) processes have been employed to functionalize plant-based proteins, however, such processes tend to generate off-flavours and chemical changes which are undesirable.

There is a need to provide a process of solubilizing insoluble plant-based proteins while preserving its organoleptic properties, for food product applications.

### SUMMARY

In one aspect, the present disclosure refers to a process for solubilizing a protein, comprising the step of:
subjecting a dispersion of an untreated protein to a pressure in the range of 250 MPa to 650 MPa and a pH in the range of 1 to 3 or 9 to 14 to solubilize the untreated protein to form the solubilized protein.

Advantageously, the process transforms insoluble, aggregated, denatured and poorly-functional plant-based proteins into soluble and functional plant-based proteins. The process may not start from native proteins, which is advantageous over conventional processes that irreversibly denature proteins to improve functional properties.

Further advantageously, subjecting the dispersion of the untreated protein to the combined parameters of pressure and pH leads to an improvement in the solubilized protein as compared to the comparative treatment of untreated protein subjected to pressure only or pH only treatment.

In another aspect, the present disclosure refers a process to form a food composition comprising the step of:
mixing a solubilized protein prepared according to the process as described herein with food ingredients to form the food composition.

### Definitions

The term “function” or “functional”, when used to refer to a protein in this disclosure, may be defined or interpreted to refer to the protein's ability to give form and function to a food system. Therefore, the function may include, but is not limited to the protein's ability to be soluble, to form a foam, to form a gel, to thicken, to emulsify, or to provide texture in the food system.

The term “insoluble, aggregated or poorly functional protein” as used herein may be defined or interpreted to refer to a protein obtained during the protein industry isolation process, whereby after a typical alkaline extraction-isoelectric precipitation, the protein-rich precipitates are redispersed in water and separated by decantation to obtain soluble and insoluble protein fractions, where the insoluble protein fractions is regarded as the “insoluble, aggregated or poorly-functional protein”.

The term “insoluble, aggregated or poorly-functional protein” as used herein may also be measured by its protein stability, where “insoluble, aggregated or non-functional protein” has a protein solubility of less than 10% at pH 7 using Lowry or BCA protein assay, has a foaming capacity of less than 30% using conventional foaming volume analyses, and/or is unable to form self-standing gels under least gelling concentration (LGC) test. The soluble protein fractions may be different from, or the same as the solubilized protein.

The term “soluble or functional protein” as used herein may be defined as or interpreted to refer to a protein having a protein solubility of more than 10% at pH 7 using Lowry or BCA protein assay, having a foaming capacity of more than 30% using conventional foaming volume analyses, being at least 300% more emulsion-stable than either the soluble or the insoluble protein fractions, and/or being able to form self-standing gels under least gelling concentration (LGC) test.

The term “foaming capacity” as used herein is calculated as the percent foaming volume compared to the initial solution.

The term “conventional foaming volume analyses” as used herein refers to the analyses involved in the “foaming capacity” method.

The term “emulsion-stable” as used herein is derived from the “Emulsifying Stability Index (ESI)” test and is a measure of the protein emulsion's ability to resist changes to its physiochemical properties over time.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

### DESCRIPTION OF OPTIONAL EMBODIMENTS

Exemplary, non-limiting embodiments of a process for solubilizing a protein will now be disclosed. The process comprises the step of subjecting a dispersion of an untreated protein to a pressure in the range of about 250 MPa to about 650 MPa and a pH in the range of about 1 to 3 or about 9 to 14 to solubilize the untreated protein to form the solubilized protein.

The subjecting step may comprise the steps of adjusting the pH of the dispersion to the range of 1 to 3 or 9 to 14; and applying the pressure in the range of 250 MPa to 650 MPa to the pH adjusted dispersion.

The untreated protein may be a plant protein or a protein obtained from a plant or plant part. The plant protein may be obtained from a plant or a plant part. The plant protein may not be particularly limited and exemplary plant proteins may be selected from albumin, globulin, prolamin, glutelin, legumin, vicilin, glutenin, oryzenin, zein or any combination thereof.

The plant or plant part may not be particularly limited and exemplarily may be selected from the group consisting of legumes, pea, mung bean, lentil, chickpea, faba bean, soy, corn, broccoli, nuts, seeds, tubers, roots, potatoes, rhizomes, grains, quinoa, seaweed, spinach, leafy vegetables, cruciferous vegetables, marrows, allium and any combination thereof.

The untreated protein may be a protein flour, a protein isolate or a protein concentrate.

The pressure that the dispersion is subjected to may be in a range of about 250 MPa to about 650 MPa, about 250 MPa to about 600 MPa, about 250 MPa to about 550 MPa, about 250 MPa to about 500 MPa, about 250 MPa to about 450 MPa about 250 MPa to about 400 MPa, about 250 MPa to about 350 MPa, about 250 MPa to about 300 MPa, about 300 MPa to about 650 MPa, about 350 MPa to about 650 MPa, about 400 MPa to about 650 MPa, about 450 MPa to about 650 MPa, about 500 MPa to about 650 MPa, about 550 MPa to about 650 MPa or about 600 MPa to about 650 MPa.

The process may be conducted in a high-pressure chamber. The pressure of 250 MPa to 650 MPa may be achieved via a hydraulic fluid medium such as water and is transmitted uniformly throughout the high-pressure chamber, so that all of the components in the dispersion is subjected to the same pressure quasi-instantaneously.

The subjecting step may comprise the step of holding the pressure at a pressure hold time in the range of about 30 seconds to about 60 minutes, about 1 minute to about 60 minutes, about 5 minutes to about 60 minutes, about 10 minutes to about 60 minutes, about 20 minutes to about 60 minutes, about 30 minutes to about 60 minutes, about 40 minutes to about 60 minutes, about 50 minutes to about 60 minutes, about 30 seconds to about 50 minutes, about 30 seconds to about 40 minutes, about 30 seconds to about 30 minutes, about 30 seconds to about 20 minutes, about 30 seconds to about 10 minutes, about 30 seconds to about 5 minutes, about 30 seconds to about 5 minutes, about 5 minutes to 60 minutes or about 3 minutes to 15 minutes.

Where the pH of the dispersion is about pH 1 to 2 or about pH 12 to 14, the pressure hold time may be in the range of about 30 seconds to about 5 minutes.

Where the pH of the dispersion is about pH 2 to 3 or about pH 10 to 12, the pressure hold time may be in the range of about 5 minutes to 60 minutes.

After the pressure hold time is achieved, the high-pressure chamber may be allowed to depressurize either instantly or at a controlled rate between about 0.5 MPa/s to about 60 MPa/s. Therefore, the process may further comprise, after the holding step, the step of releasing the pressure at the rate of about 0.5 MPa/s to about 60 MPa/s. Adiabatic heating of ˜4° C./100 MPa for water may occur, which may be lost upon depressurization.

The pH that the dispersion is subjected to may be in the range of about pH 9 to about pH14, about pH 11 to about pH 14, about pH 12 to about pH 14, about pH 13 to about pH 14, about pH 9 to about pH 13, about pH 9 to about pH 12, about pH 9 to about pH 11 or about pH 9 to about pH 10.

The pH that the dispersion is subjected to may alternatively be in the range of about pH 1 to about pH 3, about pH 2 to about pH 3 or about pH 2 to about pH 3.

The subjecting step may be undertaken at a temperature in the range of about 2° C. to about 50° C., about 2° C. to about 40° C., about 2° C. to about 30° C., about 2° C. to about 20° C., about 2° C. to about 10° C., about 4° C. to about 8° C., about 12° C. to about 50° C., about 22° C. to about 50° C., about 32° C. to about 50° C. or about 42° C. to about 50° C. The temperature may be in the range of about 4° C. to about 6° C.

Advantageously, the temperature range used in the process is lower than conventional processes (such as high temperature thermal treatment processes) which may aid in preserving the organoleptic properties of the solubilized protein.

After depressurization, the pH of the dispersion may be further adjusted to be in the pH range of about pH 6 to about pH 8.

The process may further comprise, before the subjecting step, the step of dispersing the untreated protein. The untreated protein may be dispersed in a liquid medium. The liquid medium may be an aqueous medium. The aqueous medium may be water.

The amount of untreated protein in the dispersion may be up to about 70% total solids (w/w), or about 10% to about 70%, about 10% to about 50%, about 10% to about 30%, about 30% to about 70%, about 50% to about 70%, or about 10% to about 30% total solids (w/w), based on the weight of the dispersion.

The dispersion may be stirred using conventional means, such as hand stirring, using a stirrer bar or shear mixing. The dispersion may be stirred for a duration that is sufficient to achieve a well dispersed mixture.

The pH of the dispersion may be acidic (between about pH 1 to about pH 3) or may be alkali (between about pH 9 to about pH 14) before being subjected to the pressure in the range of about 250 MPa to about 650 MPa.

The dispersion may be vacuum sealed in a flexible package after pH adjustment and before applying the pressure to the dispersion.

After the solubilized protein is formed, the solubilized protein may be stored under low temperature conditions, in a temperature range of about 0° C. to about 20° C., about 5° C. to about 20° C., about 10° C. to about 20° C., about 15° C. to about 20° C., about 0° C. to about 15° C., about 0° C. to about 10° C. or about 0° C. to about 10° C.

The solubilized protein may be further subjected to treatment steps such as dehydrating step. The dehydrating step may comprise freeze drying, spray drying, oven drying or vacuum drying.

Where the dehydrating step is absent, the solubilized protein may be in the form of a paste, or a gel, or a liquid. Where the dehydrating step is present, the solubilized protein may be in the form of a powder, or granules.

The solubilized protein may be used to form a food composition.

In one example, the solubilized protein treated according to the process as described herein may have about 100% to about 300% increase in protein solubility as compared to a solubilized protein treated with the same pressure only or same pH only.

In another example, the solubilized protein treated according to the process as described herein may have about a 2-fold (from 20% to 45%) increase in the foaming capacity as compared to a solubilized protein treated with the same pressure only or same pH only.

In another example, the solubilized protein treated according to the process as described herein may have about 300% to about 1 000% increase in the emulsion stability as compared to a solubilized protein treated with the same pressure only or same pH only.

The solubilized protein treated according to the process as described herein may be capable of gelation with a least gelling concentration that varies based on the protein's source. Where the protein is a pea protein, the least gelling concentration may be at least 13% (w/w) as compared to solubilized pea proteins treated with the same pressure only that are not able to form gels.

In another example, the solubilized protein treated according to this disclosure may have a different morphology as compared to a solubilized protein treated with the same pressure only or same pH only. The solubilized protein treated according to this disclosure may form larger-sized particle chunks with a pitted surface as compared to a solubilized protein treated with the same pressure only or same pH only that are irregularly shaped particles with rough surfaces.

Exemplary, non-limiting embodiments of a process to form a food composition will now be disclosed. The process of forming the food composition comprises the step of mixing a solubilized protein prepared according to the process as described herein with food ingredients to form the food composition.

The food ingredients is not particularly limited and exemplarily may be selected from food colouring, food preservatives, food flavourings, food lipids, hydrocolloids, sugars, gums, polysaccharides, salts, acids, vitamins, minerals or any combination thereof.

The mixing step may be conducted at a temperature range of about −30° C. to about 60° C., about-15° C. to about 60° C., about 0° C. to about 60° C., about 15° C. to about 60° C., about 30° C. to about 60° C., about 45° C. to about 60° C., about −30° C. to about 45° C., about −30° C. to about 30° C., about −30° C. to about 15° C., about-30° C. to about 0° C., about −30° to about −15° C. or about −20° C. to about 50° C., for a duration of about 1 minute to about 240 minutes, about 10 minutes to about 240 minutes, about 60 minutes to about 240 minutes, about 120 minutes to about 240 minutes, about 180 minutes to about 240 minutes, about 1 minute to about 180 minutes, about 1 minute to about 120 minutes, about 1 minute to about 60 minutes or about 1 minute to about 10 minutes.

The food composition may be in the form of a paste, a gel, a liquid, a powder or granules.

The food composition may be beverages, ice creams, yoghurts, or plant-based foods that have specific applications for children, the elderly and for sports nutrition.

### BRIEF DESCRIPTION OF THE DRAWINGS

The accompanying drawings illustrate disclosed embodiments and serve to explain the principles of the present disclosure. It is to be understood, however, that the drawings are designed for purposes of illustration only, and not as a definition of limits of the invention.

FIG. 1 shows a line graph comparing Protein Solubility (%) of a commercial soluble pea protein, a commercial insoluble pea protein and an insoluble pea protein after processing with either high-pressure (400 MPa or 600 MPa) or pH treatment, against pH.

FIG. 2 shows a line graph comparing Protein Solubility (%) of a commercial soluble pea protein, a commercial insoluble pea protein and an insoluble pea protein after processing by the process as described herein (400 MPa, pH 12 or 600 MPa, pH 12), against pH.

FIG. 3 shows a bar graph comparing the Foaming Capacity (%) of a commercial soluble pea protein, a commercial insoluble pea protein, an insoluble pea protein after processing with either high-pressure (400 MPa or 600 MPa) or pH treatment and an insoluble pea protein after processing by the process as described herein (400 MPa, pH 12 or 600 MPa, pH 12).

FIG. 4 shows a bar graph comparing the Foaming Stability (%) of a commercial soluble pea protein, a commercial insoluble pea protein, an insoluble pea protein after processing with either high-pressure (400 MPa or 600 MPa) or pH treatment and an insoluble pea protein after processing by the process as described herein (400 MPa, pH 12 or 600 MPa, pH 12).

FIG. 5 shows a bar graph comparing the Emulsifying Activity Index (m²/g) of a commercial soluble pea protein, a commercial insoluble pea protein, an insoluble pea protein after processing with either high-pressure (400 MPa or 600 MPa) or pH treatment and an insoluble pea protein after processing by the process as described herein (400 MPa, pH 12 or 600 MPa, pH 12).

FIG. 6 shows a bar graph comparing the Relative Emulsion Stability of a commercial soluble pea protein, a commercial insoluble pea protein, an insoluble pea protein after processing with either high-pressure (400 MPa or 600 MPa) or pH treatment and an insoluble pea protein after processing by the process as described herein (400 MPa, pH 12 or 600 MPa, pH 12).

FIG. 7a shows a scanning electron microscope (SEM) micrograph of a commercial soluble pea protein and FIG. 7b shows a SEM image micrograph of a commercial insoluble pea protein. The magnification is 250×.

FIG. 8a shows a SEM micrograph of an insoluble pea protein treated by pH, FIG. 8b shows a SEM micrograph of an insoluble pea protein treated at 400 MPa, and FIG. 8c shows a SEM micrograph of an insoluble pea protein treated at 600 MPa. The magnification is 250×.

FIG. 9a shows a SEM micrograph of an insoluble pea protein treated by a combination of 400 MPa and pH, and FIG. 9b shows a SEM micrograph of an insoluble pea protein treated by a combination of 600 MPa and pH. The magnification was 250×.

### EXAMPLES

Non-limiting examples of the invention will be further described in greater detail by reference to specific examples, which should not be construed as in any way limiting the scope of the inventions.

### Example 1: Preparation of Solubilized Protein

A concentration of 10% (w/w) of untreated insoluble pea protein (NUTRALYS® B85F insoluble pea protein, Roquette, Singapore Pte. Ltd.) was first dispersed in water and stirred overnight. The pH of the dispersed protein solution was then adjusted to pH 12 using 0.1 M NaOH (obtained from Thermo Fisher Scientific, Waltham, MA, USA). The mixture was then vacuum sealed in a flexible package (Ziploc®)

The vacuum sealed package was then placed in a high-pressure chamber (Hiperbaric 300, Burgos, Spain) and a pressure of 400 MPa or 600 MPa was transmitted throughout the chamber uniformly via a hydraulic fluid medium, such as water, to ensure that all components of the vacuum sealed package are subjected to the same pressure quasi-instantaneously. The pressure was applied for a hold time of 5 minutes and subsequently, the chamber was allowed to depressurise at a controlled rate between 0.5 MPa/s to 60 MPa/s. Throughout the procedure, the temperature was maintained between 4° C. to 6° C. After the treatment, the pH of the protein suspensions was adjusted to neutral (between pH 6 to pH 8) using 0.1 M HCl (obtained from Thermo Fisher Scientific, Waltham, MA, USA) and stored under refrigeration until further use.

To prepare the protein suspensions for analysis, the protein suspensions were lyophilised (4KXL, VirTis, United States of America), grounded, passed through a 200 μm sieve (Endecotts Ltd, England) and stored in a desiccator at 25° C.

### Example 2: Method and Results for Protein Solubility

1% (w/w) protein samples were dispersed in water and stirred overnight. The pH of the dispersion was adjusted to pH 2, 4, 6, 7, 8 and 10 using 0.1 M HCl (obtained from Thermo Fisher Scientific, Waltham, MA, USA) and 0.1 M NaOH (obtained from Thermo Fisher Scientific, Waltham, MA, USA). The dispersed samples were then centrifuged at 8 000 rcf for 10 minutes at 23° C. and the supernatant used for quantification of soluble proteins. Protein concentration was determined using the Braford method (Sigma Chemical Co., St. Louis, MO, USA). Bovine Serum albumin (obtained from Pierce™, Thermo Fisher Scientific, Waltham, MA, USA) was used to construct the standard curve and the absorbance was measured at 595 nm in a Cytation 5 Multi-Mode Reader (BioTek, Winooski, VT, USA). The solubility was measured according to the following equation:

$$Solubility ( \% ) = \frac{p r otein concentration in the supernatant ( μg / μL )}{i n itial protein concentration ( μg / μL )} \times 100 \%$$

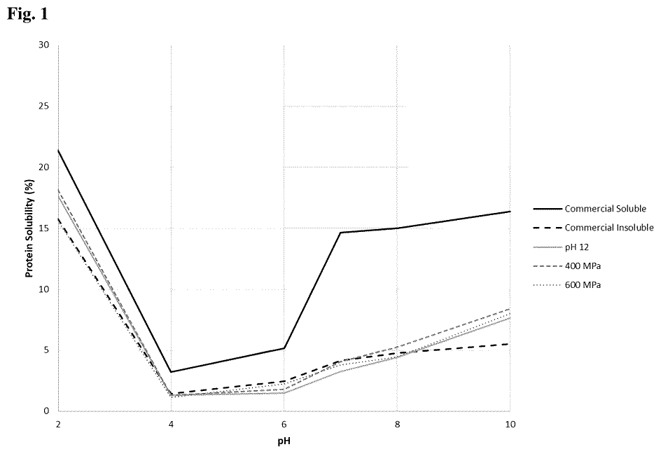

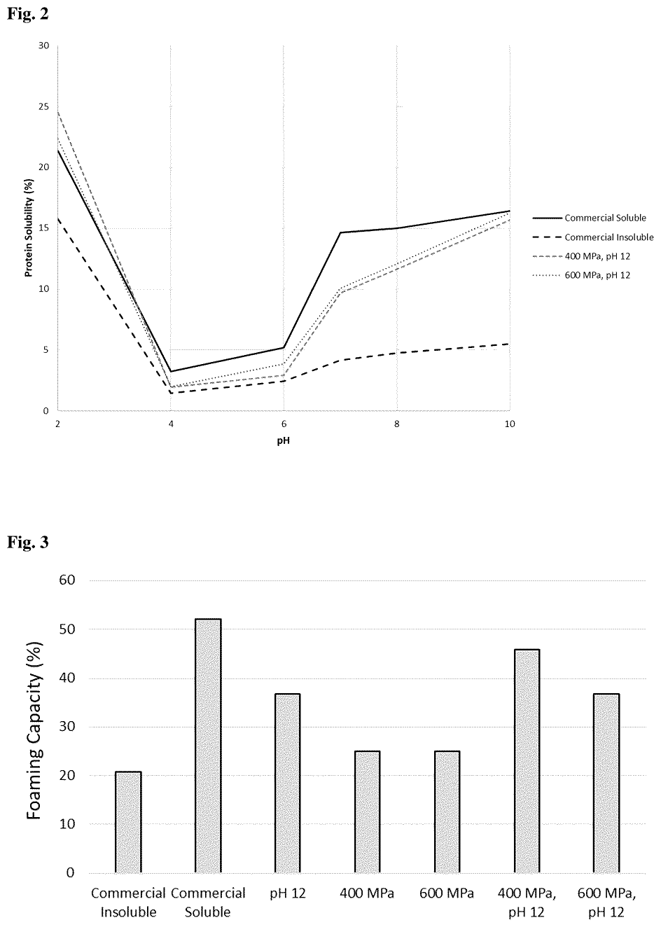

FIG. 1 and FIG. 2 show the protein solubility of insoluble pea protein after various processing treatments. Untreated commercial soluble (NUTRALYS® S85F soluble pea protein, Roquette, Singapore Pte. Ltd.) and insoluble pea proteins (NUTRALYS® B85F insoluble pea protein, Roquette, Singapore Pte. Ltd.) were used as reference. As seen from FIG. 1, there was little improvement in protein solubility treated with only high-pressure (400 MPa or 600 MPa, neutral pH) or pH (pH 12, unpressurized), compared to untreated commercial insoluble pea protein. Surprisingly, as seen from FIG. 2, the combination of high-pressure with pH treatment led to a markedly improvement in protein solubility that was close to commercial soluble pea protein.

### Example 3: Method and Results for Foaming Capacity and Stability

1% (w/w) protein samples were dispersed in water and stirred overnight. 20 mL of the dispersed protein solution was transferred into a 50 mL graduated centrifuge tube and foam was prepared by homogenizing the solution using T25 digital UltraTurrax fitted with a S58N-18G dispersion tool (obtained from IKA Works Inc., Wilmington, NC, USA) at 12 000 rpm for 2 minutes. Foaming capacity was calculated as the percent foaming volume compared to the initial solution volume and foam stability was estimated as the percentage of foam remaining after 30 minutes of storage at 23° C. The foaming capacity and stability were measured according to the following equations:

$$Foaming capactiy ( \% ) = \frac{{V}_{1} - {V}_{0} ( mL )}{{V}_{0} ( mL )} \times 100 \%$$

$$Foaming stability ( \% ) = \frac{{V}_{2} ( mL )}{{V}_{1} ( mL )} \times 100 \%$$

where V₀ is the initial solution volume, V₁ is the foaming volume and V₂ is the foaming volume at 30 minutes.

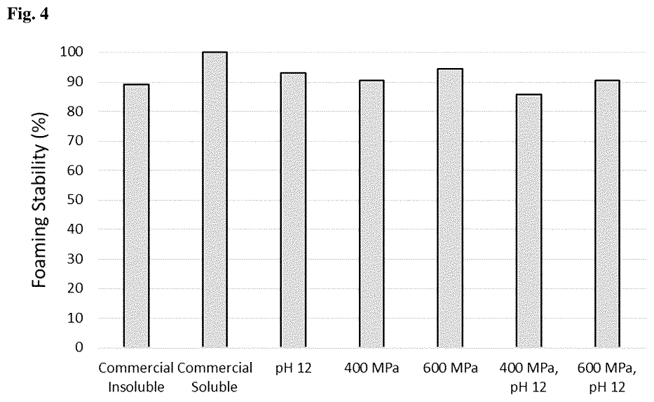

FIG. 3 and FIG. 4 show the foaming capacity and stability of insoluble pea protein after various processing treatments. Untreated commercial soluble and insoluble pea proteins were used as reference. As seen from FIG. 3, there was little improvement in the foaming capacity of insoluble pea proteins with only high-pressure (400 MPa or 600 MPa, neutral pH) treatment. Foaming capacity improved from ˜20% to ˜35% with only pH treatment (pH 12, unpressurized). However, there was great improvement in the foaming capacity (up to ˜45%) when the protein was treated in combination with high-pressure and pH, and is close to the foaming capacity of the commercial soluble pea protein (˜50%). As seen from FIG. 4, the foaming stability remained similar across all samples.

### Example 4: Method and Results for Emulsifying Activity Index (EAI), Emulsifying Stability Index (ESI) and Relative Emulsion Stability

1% (w/w) protein samples were dispersed in water and stirred overnight. 15 mL of the dispersed protein solution and 5 mL of soybean oil was transferred into a 50 ml graduated centrifuge tube. The emulsion was prepared by homogenizing the mixture using using T25 digital UltraTurrax fitted with a S58N-18G dispersion tool (obtained from IKA Works Inc., Wilmington, NC, USA) at 10 000 rpm for 2 minutes. Subsequently, 80 μL of the resulting emulsion and 4 mL of 0.1% SDS solution (obtained from Sigma-Aldrich, St Louis, MO, USA) was pipetted into a cuvette and the resultant mixture absorbance measured at 500 nm using a UV-Visible spectrophotometer at 0 minute and 10 minute. The EAS and ESI were calculated using the following equations:

$$EAI ( \frac{{m}^{2}}{g} ) = \frac{( 2 \times 2.303 \times {A}_{0} \times N )}{( c \times Φ \times 10 \; 000 )}$$

$$ESI ( min ) = \frac{{A}_{0}}{Δ A} \times t$$

where N is the dilution factor, c is the concentration of protein (g/mL), ϕ is the oil volume fraction of the emulsion, A₀ is the absorbance at 0 minutes, A₁₀ is the absorbance at 10 minutes, ΔA is the change in absorbance (A₁₀−A₀) and t is 10 minutes.

The relative emulsion stability was calculated according to the following equation:

$$Realtive Emulsion Stability = \frac{{ESI}_{sample}}{{ESI}_{reference}}$$

where the untreated commercial soluble pea protein was used as the reference.

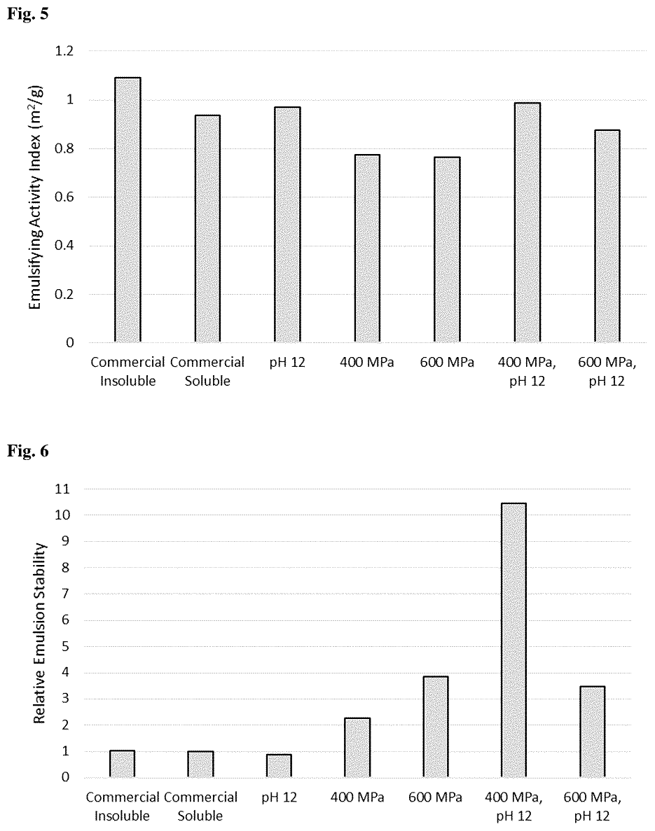

FIG. 5 and FIG. 6 show the emulsifying activity index (EAI) and relative emulsion stability of insoluble pea protein after various processing treatments. Untreated commercial soluble and insoluble pea proteins were used as reference. As seen from FIG. 5, the EAI decreased after high-pressure treatment (400 MPa or 600 MPa, neutral pH) while the EAI for the combination treatment of high-pressure and pH was retained. Most notably, as seen from FIG. 6, the emulsion stability of insoluble pea proteins treated with the combination of high-pressure and pH was up to over 10 times that of both commercial soluble and insoluble pea proteins. This suggests an unexpected synergistic behaviour which cannot be explained by either high-pressure treatment or pH treatment alone.

### Example 5: Method and Results for Least Gelling Concentration (LGC)

The LGC was determined using a method adapted from O'Kane et. al. 2005. Protein sample solutions of 10 mL were made at protein concentration between 12-15% (w/w) in 1% (w/w) increments and stirred overnight. Each protein sample was then poured into sealed tubes and were heated at 95° C. in a shaking water bath for 1 hours. The samples were then cooled in an ice bath for 1 hour and the tubes were then taking out of the ice bath and inverted. The sample with the lowest concentration that did not flow was considered to be the LGC.

Commercial insoluble pea protein and high-pressure treated (400 MPa or 600 MPa, neutral pH) insoluble proteins could not form gels. The commercial soluble pea protein had a LGC of 13% (w/w). Significantly, insoluble pea proteins that were treated with pH only or combination of high-pressure and pH (400 MPa, pH 12 or 600 MPa, pH 12) became capable of gelation and had a LGC of 13% (w/w).

### Example 6: Method and Results for Scanning Electron Microscopy (SEM)

Protein samples were lyophilised according to a procedure known to a person skilled in the art. The morphologies of lyophilised protein sample powders were analysed using scanning electron microscopy (SEM). Samples were mounted on aluminium stubs using double sided carbon tape with excess of powder removed by dust blower. The prepare stubs were coated with 4 nm layer of platinum using Leica EM SCD050 cold sputter coating device and analysed in JSM 6701F SEM. Images were collected using fixed accelerating voltage of 2.5 kV at magnification 250×.

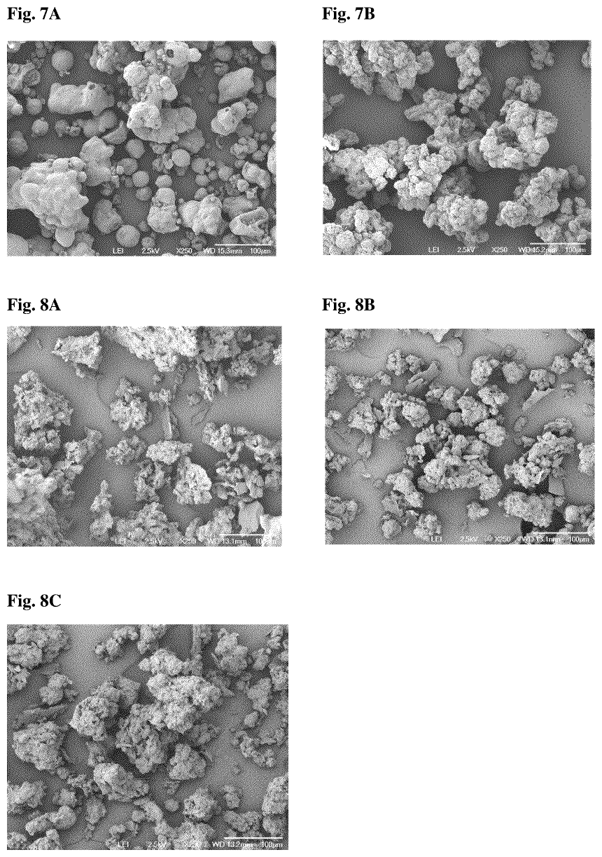

As seen from FIG. 7, both commercial soluble (FIG. 7a) and insoluble (FIG. 7b) pea protein displayed a spherical morphology. It can be seen from FIG. 7a that the commercial soluble pea protein has a smooth surface while the commercial insoluble pea protein, as seen from FIG. 7b, has aggregated-like clusters on the surface.

As seen from FIG. 8, the proteins treated with either pH (FIG. 8a), high-pressure of 400 MPa (FIG. 8b) or high-pressure of 600 MPa (FIG. 8c) only, all displayed irregularly shaped morphologies with rough surfaces.

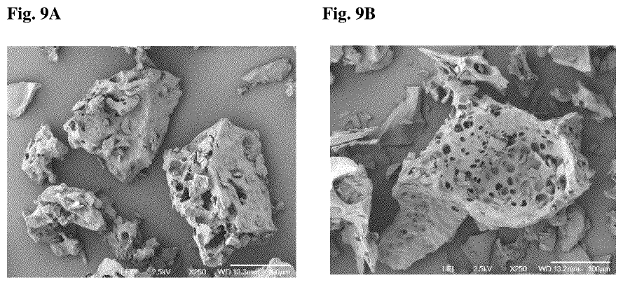

As seen from FIG. 9, a unique morphology was observable for insoluble pea protein treated with a combination of high-pressure and pH (400 MPa, pH 12—FIG. 9a; 600 MPa, pH 12—FIG. 9b). The insoluble pea protein treated with a combination of high-pressure and pH have relatively larger particles (average diameter ˜165 μm) with smooth surfaces and well-defined round pores. This morphology is visually distinct from the commercial soluble and insoluble proteins, and the proteins treated by either high-pressure only or pH only.

### Summary of Examples

The process of solubilizing an insoluble plant protein as described herein has improved the functionality of an otherwise unusable plant protein. The process of high-pressure and pH treatment has improved the solubility of insoluble plant protein over high-pressure only or pH only treatment. It has also improved the foaming capacity to a level comparable to that of commercial soluble plant protein and has greatly improved the emulsion stability over commercial soluble and insoluble plant protein with good retention in the emulsion activity index. Further, the process as described herein allows gelation of otherwise non-gellable insoluble plant proteins with a least gelation concentration comparable to that of commercial soluble plant protein.

### INDUSTRIAL APPLICABILITY

The process of solubilizing a plant-based protein as described herein may be used for the production of a food composition. The process transforms insoluble, aggregated, denatured and poorly functional plant-based proteins into soluble and functional plant-based proteins which may be used for the production of food compositions that could help to address food security concerns by providing a viable way to process plant-based proteins which are otherwise underutilized.

It will be apparent that various modifications and adaptations of the invention will be apparent to the person skilled in the art after reading this foregoing disclosure without departing from the spirit and scope of the inventions and it is intended that all such modifications and adaptations come within the scope of the appended claims

1. A process for solubilizing a protein comprising the step of:
subjecting a dispersion of an untreated protein to a pressure in a range of 250 Mpa to 650 Mpa and a pH in a range of 1 to 3 or 9 to 14 to solubilize the untreated protein to form the solubilized protein.

2. The process of claim 1, wherein the subjecting step comprises the steps of:
adjusting the pH of the dispersion to a range of 1 to 3 or 9 to 14; and
applying the pressure in the range of 250 Mpa to 650 Mpa to the pH adjusted dispersion.

3. The process of claim 1, wherein the untreated protein is a plant protein or a protein obtained from a plant or a plant part.

4. The process of claim 3, wherein the plant protein is selected from the group consisting of albumin, globulin, prolamin, glutelin, legumin, vicilin, glutenin, oryzenin, zein, and any combination thereof.

5. The process of claim 3, wherein the plant or the plant part is selected from the group consisting of legumes, pea, mung bean, lentil, chickpea, faba bean, soy, corn, broccoli, nuts, seeds, tubers, roots, potatoes, rhizomes, grains, quinoa, seaweed, spinach, leafy vegetables, cruciferous vegetables, marrows, allium, and any combination thereof.

6. The process of claim 1, further comprising, before the subjecting step, the step of dispersing the dispersion in a liquid medium.

7. The process of claim 6, wherein the dispersion of the untreated protein in the liquid medium comprises up to 70% (w/w) solids, based on the weight of the dispersion.

8. The process of claim 1, wherein the subjecting step comprises the step of holding the pressure at a pressure hold time in a range of 30 seconds to 60 minutes.

9. The process of claim 8, further comprising, after the holding step, the step of releasing the pressure at a rate of 0.5 Mpa/s to 60 Mpa/s.

10. The process of claim 1, wherein the subjecting step is undertaken at a temperature in a range of 2° C. to 50° C.

11. The process of claim 1, further comprising, after the subjecting step, a step of dehydrating the solubilized protein.

12. The process of claim 11, wherein the dehydrated solubilized protein is in the form of a powder or granules.

13. The process of claim 1, wherein the solubilized protein is in the form of a paste, a gel, or a liquid.

14. The process of claim 1, wherein the pH is in a range of pH 2 to pH 3.

15. The process of claim 1, wherein the pH is in a range of pH 10 to pH 12.

16. A process of forming a food composition comprising the step of:
mixing a solubilized protein with food ingredients to form the food composition, wherein the solubilized protein is prepared by subjecting a dispersion of an untreated protein to a pressure in a range of 250 Mpa to 650 Mpa and a pH in a range of 1 to 3 or 9 to 14 to solubilize the untreated protein.

17. The process of claim 16, wherein the food ingredients is selected from the group consisting of food coloring, food flavorings, food preservatives, food lipids, hydrocolloids, sugars, gums, polysaccharides, salts, acids, vitamins, minerals, and any combination thereof.

18. The process of claim 16, wherein the mixing step is undertaken at a temperature in a range of −30° C. to 60° C.

19. The process of claim 16, wherein the mixing step is undertaken for a duration of 1 minute to 240 minutes.
